(19) United States
(12) Patent Application Publication
(10) Pub. No.: US 2010/0107363 A1
(43) Pub. Date: May 6, 2010

(54) Detachable pull handle for an inflator regulator airway hose

(76) Inventor: Yannick Marcel Bonnemaiso, Oceanside, CA (US)

Correspondence Address: VENABLE, CAMPILLO, LOGAN & MEANEY, P.C., 1938 E. OSBORN RD, PHOENIX, AZ, 85016-7234, US

(21) Appl. No.: 12/262,118

(22) Filed: Oct. 30, 2008

(51) Int. Cl. A62B 9/00

(52) U.S. Cl. 16/110.1; 29/525.01

(57) ABSTRACT

An attachable and detachable pull handle for dissecting an airway hose used to join a buoyancy compensator and an inflator-regulator that enables a scuba diver to store the buoyancy compensator and inflator-regulator separately for easier maintenance. The pull handle allows the diver to create an airtight secure connection between the airway hose portions connected to the buoyancy compensator and inflator-regulator respectively. The secured connection is formed by providing a rotating locking mechanism that is also easily locked or unlocked by rotating the upper and lower portions of the pull handle in opposite directions.

### BACKGROUND OF THE INVENTION

1. Field of the Invention

The present invention relates generally to scuba diving equipment, and in particular, second-stage inflator/regulator devices. Specifically, the invention relates to a detachable pull handle that enables a diver to separate the regulator portion of the device from a mechanism used to connect to a buoyancy compensator.

2. Discussion of the Related Art

Scuba divers typically use several standard pieces of equipment. Two standard pieces are buoyancy compensators and pressurized air tanks. These two pieces of equipment work in tandem. The buoyancy compensator is an inflatable pack that allows the diver to adjust and control the overall buoyancy of the diver and his heavy equipment. The buoyancy compensator enables the diver to achieve neutral buoyancy, remain at constant depth, or to descend and ascend in a controlled manner. The pressurized air tank contains compressed air that can either be used to breathe or to inflate the buoyancy compensator during a dive. The air delivery from the air tank is controlled by a first and a second stage regulator. In some cases, the buoyancy compensator and the pressurized air tank are connected by a second-stage regulator device that can simultaneously switch between providing air to breathe or to inflate the buoyancy compensator.

Second-stage regulator devices that integrate both air supply and inflation functions are well known in the art. These inflator-regulator devices typically have two hoses, one connected to the buoyancy compensator and one connected to the first-stage regulator. The hose that connects to the buoyancy compensator is typically a corrugated hose which connects to the second-stage inflator-regulator.

Many divers, however, fail to maintain the inflator-regulator on a regular basis because the inflator-regulator's hoses are often difficult to disconnect from the pressurized air tank and buoyancy compensator. Therefore, it is desirable to provide an easy method to detach the buoyancy compensator from the second stage inflator-regulator without having to remove the secure fittings used to attach the hoses between the inflator-regulator and pressurized air tank and buoyancy compensator respectively.

At present, there is only one known system disclosed in U.S. Pat. No. 6,761,163 to Toth. The Toth patent discloses a second-stage inflator regulator having a threaded sleeve whereby multiple adapters can be used to connect different size buoyancy compensator hoses. The Toth patent discloses the ability for a diver to remove a hose by unscrewing it where it connects to the inflator-regulator. This allows the diver to remove the buoyancy compensator hose from the inflator-regulator for storage purposes. The Toth patent, however, has two primary disadvantages. First, the threaded connections for the buoyancy compensator hoses must be tightly secured to the inflator-regulator. This means the hoses are not easily removed by hand and often will require a pliers or small wrench to loosen the hose from the inflator-regulator. Second, the threaded connector design being located at the inflator-regulator, it does not allow the diver to deflate its buoyancy compensator when the inflator-regulator is in the diver's mouth.

Therefore, it would be advantageous if a diver could have a simple means to detach a buoyancy compensator hose from an inflator-regulator without the need for any special tools that would enable easy detachment of the buoyancy compensator for storage and maintenance purposes.

### SUMMARY OF THE INVENTION

Broadly, it is an object of the present invention to provide a second-stage inflator regulator apparatus used by scuba divers that overcomes the shortcomings of the prior art;

It is a further object to provide a disconnectable pull handle embedded within a scuba diving airway that enables a diver to sever the airway between the second-stage inflator-regulator and the buoyancy compensator to simplify the storage and maintenance of the buoyancy compensator;

It is a further object to provide a disconnectable pull handle that comprises two individual hoses that hook together by a locking mechanism;

It is a further object to provide a locking mechanism that engages by joining two mating connectors that are locked into position when they are rotated in opposite directions;

It is a further object of the pull handle that when the two connectors are locked into position that an airtight seal is created through the use of an o-ring seal;

It is a further object of the pull handle that when the diver wishes to detach the pull handle that the locking mechanism is disengaged;

It is a further object of the pull handle that when the locking mechanism disengages, the two mating connectors are rotated and pulled in opposite directions with minimal effort from the diver;

The description of the invention which follows, together with the accompanying drawings should not be construed as limiting the invention to the example shown and described, because those skilled in the art to which this invention appertains will be able to devise other forms thereof within the ambit of the appended claims.

### BRIEF DESCRIPTION OF THE DRAWINGS

FIG. 1 is a side close-up view of the pull handle showing the two connectors separated from each other;

FIG. 2 is a side view of the pull handle showing the two connectors in a closed position;

FIG. 3 is a side view of the pull handle showing the lower connector in the open position after it has been turned one quarter counterclockwise from the position shown in FIG. 2;

FIG. 4 is a side view of the pull handle showing the lower connector separated from each other in a position immediately after it has been pulled downward from the position shown in FIG. 3.

FIG. 4 is an exploded view of the pull handle section; and

FIG. 5 is a perspective view of the entire inflator-regulator with the pull handle device shown in the center portion of the airway tube.

### DESCRIPTION OF AN EMBODIMENT

By way of one example of many to serve as background in understanding the preferred embodiment of the present invention, as shown in FIG. 6, is a complete breathable inflator regulator system 100 used by scuba divers. Typically, a medium pressure hose 150 is connected to a pressurized air tank by way of a first-stage regulator (not shown). A diver can breathe air provided from the air tank at the mouthpiece 130 from the hose 150 through the inflator-regulator 240 presuming the cut-off valve 210 is in the open position. When the power inflation button 220 is activated, the pressurized air can also be used to inflate a buoyancy compensator (not shown), which is connected to the relief valve 180. When desired, pressurized air will flow through the inflator-regulator 240 up the airway 140 through the relief valve 180 into the buoyancy compensator so that the compensator will fill to the desired amount. In most inflator regulator systems, the airway 140 consists of a single tube typically in the form of a corrugated hose.

A pull handle 170 is typically found on the airways of many inflator-regulators—typically in the middle portion of the airway 140. The pull handle 170 is a unitary element that is typically used to release air from the buoyancy compensator by pulling down on the pull handle 170 during a dive. In the preferred embodiment, the pull handle 170 has been improved to allow a diver to disconnect the airway 140 into two distinct pieces, an upper hose 120 and a lower hose 110. By disconnecting the upper hose 120 from the lower hose 110, the diver can store the inflator-regulator 240 with his breathing equipment instead of his buoyancy control equipment. This allows the diver to maintain his buoyancy control equipment more easily. Additionally, the pull handle 170 allows an inflator-regulator design without the typical quick disconnection on the pressure hose 150 found on most inflator-regulators.

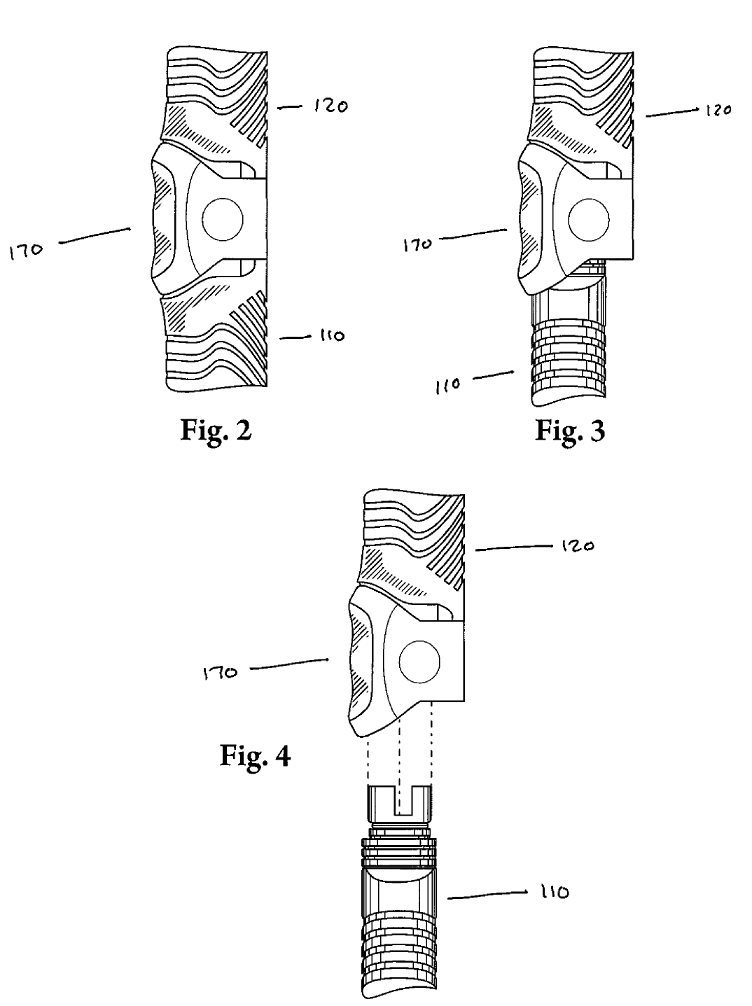

A close up view of the pull handle 170 in the fully locked position is shown in FIG. 2. The pull handle 170 joins the upper hose 120 and lower hose 110. When a diver wishes to detach the upper hose 120 and lower hose 110, the diver simply turns the lower hose 110 counterclockwise (or the upper hose 120 clockwise) to the unlocked position as shown in FIG. 3. Once the lower hose 110 and the upper hose 120 are in the position shown in FIG. 3, the diver can detach the upper hose 120 and lower hose 110 by simply pulling the two hoses apart as shown in FIG. 4.

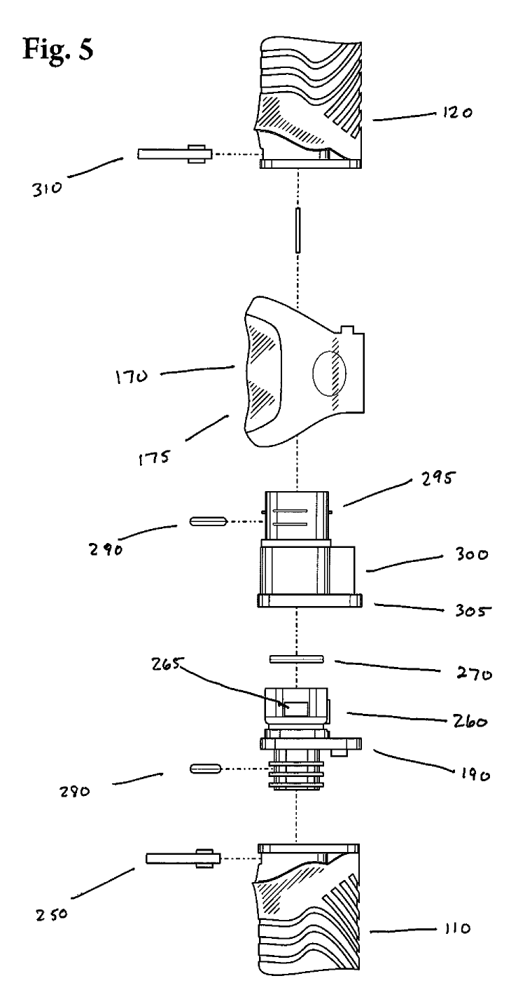

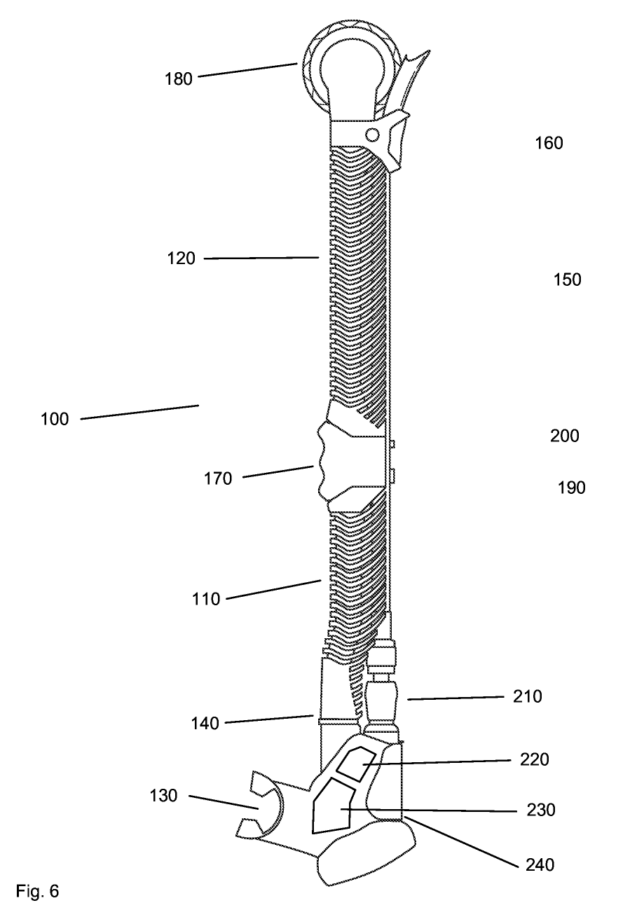

FIG. 5 shows a more detailed view of how the pull handle is secured or unlocked. A first clamp 310 provides an airtight seal between the upper hose 120 and the pull handle 170. The lower hose 110. The pull handle 170 comprises an upper connector 300 that includes a securing bar 290 that stretches across the diameter of the upper portion 295 of the upper connector 300. The upper connector also includes a pair of pressurized hose guides 200 and 305 to secure the pressurized hose 150 to the pull handle 170.

A second clamp 250 provides an airtight seal between the lower hose 110 and the lower connector 260. The lower connector 260 further comprises an o-ring 270, which secures an airtight seal between the upper hose 120 and lower hose 110 when the pull handle is in the locked position as shown in FIG. 2. The lower connector 260 also includes an additional pressurized hose guide 190, which is used to secure the pressurized hose 150 to the lower hose 110. The upper portion of the lower connector 260 comprises a rotatable mating connector 265. The rotatable mating connector 265 further comprises a first 267 and second 268 protrusion.

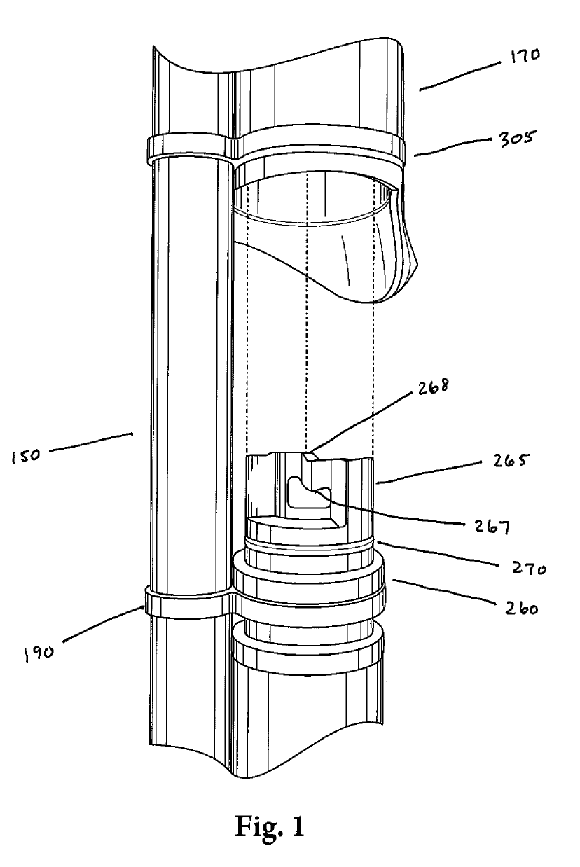

As shown in FIG. 1, the lower hose 110 and upper hose 120 are secured when the lower connector 260 and upper connector 300 are axially joined together. When the lower connector 260 and upper connector 300 are joined, the rotatable mating connector 265 rests on top of the securing bar 290. When the rotatable mating connector 265 is rotated a quarter turn clockwise, such that the first protrusion 267 and the second protrusion 268 snap on to the securing bar 290, the upper hose 120 and lower hose 110 are secured in an airtight fashion. Although the pull handle 170 will typically remain locked when it is secured as shown in FIG. 2, it is recommended that the pressurized hose 150 be fixed firmly into the guides 190, 200, and 305 during a dive to ensure that the pull handle 170 is not accidentally unlocked.

As stated above, to unlock the upper connector 300 and lower connector 260, the lower connector 260 needs simply to be rotated a quarter turn in the counterclockwise direction such that the first 267 and second protrusions 268 snap off of the securing bar 290, which will enable the upper hose 120 and lower hose 110 to be pulled apart.

While the apparatus for practicing the within inventive method, as well as said method herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

Although the invention has been described in detail with reference to one or more particular preferred embodiments, persons possessing ordinary skill in the art to which this invention pertains will appreciate that various modifications and enhancements may be made without departing from the spirit and scope of the claims that follow.

What is claimed is:

1. A detachable pull handle for an air regulator hose comprising:
a. an upper connector, said upper connector further comprising a first and second end, such that said upper connector is adapted to secure to a first end of an upper airway hose;
b. a lower connector, said lower connector further comprising a first and second end, such that said lower connector is adapted to secure to a first end of a lower airway hose;
c. such that said upper and lower connectors form a secure seal when the second end of said upper connector is axially coupled to the second end of said lower connector.

2. The detachable pull handle of claim 1 wherein:
a. the second end of said lower connector further comprises a mating connector;
b. the upper connector further comprises a securing bar such that said securing bar extends across the width of said upper connector;
c. such that when said upper connector is axially coupled to said second end of said lower connector, and said lower connector is rotated in a direction opposite to that of said upper connector, said mating connector locks onto said securing bar.

3. The detachable pull handle of claim 2 wherein:
a. the lower connector further comprises an o-ring such that said o-ring forms an airtight seal between said upper and lower connectors when said mating connector locks onto said securing bar.

4. The detachable pull handle of claim 3 wherein:
a. said mating connector further comprises at least one protrusion such that when said mating connector locks onto said securing bar, said protrusion snaps onto said securing bar.

5. The detachable pull handle of claim 1 wherein:
a. when said lower connector is rotated in a direction opposite that of said upper connector when said upper and lower connectors while axially coupled, said secure seal is broken such that said upper and lower airway hoses may be pulled apart and stored separately from each other.

6. A method of forming a continuous airway between a buoyancy compensator and an inflator regulator comprising the steps of:
a. securing an upper connector to a first end of an upper airway hose;
b. securing a lower connector to a first end of a lower airway hose;
c. axially coupling a second end of said upper connector to a second end of said lower connector such that said upper and lower connectors form a secure seal.

7. The method of claim 6 further comprising the steps of:
a. providing a mating connector to the second end of said lower connector;
b. providing a securing bar across the width of said upper connector;
c. axially coupling said second end of said lower connector;
d. rotating said lower connector in a direction opposite to that of said upper connector; and
e. locking said mating connector onto said securing bar.

8. The method of claim 7 further comprising the step of:
a. coupling an o-ring to said lower connector so that when said mating connector locks onto said securing bar, said o-ring forms an airtight seal between said upper and lower connectors.

9. The method of claim 8 further comprising the steps of:
a. forming a protrusion on said mating connector; and
b. locking said mating connector onto said securing bar by snapping said protrusion onto said securing bar.

10. The method of claim 6 further comprising the steps of:
a. axially decoupling the second end of said upper connector from the second end of said lower connector; and
b. pulling said upper and lower airway hoses in opposite directions such that said upper and lower airway hoses may be stored separately from each other.
